(19) United States
(12) Patent Application Publication
(10) Pub. No.: US 2011/0216202 A1
(43) Pub. Date: Sep. 8, 2011

(54) TRAFFIC SIGN CLASSIFICATION SYSTEM

(75) Inventors: Koba Natroshvili, Waldbronn (DE); Ayyappan Mani, Karlsruhe (DE)

(73) Assignee: Harman Becker Automotive Systems GmbH, Karlsbad (DE)

(21) Appl. No.: 13/041,073

(22) Filed: Mar. 4, 2011

(30) Foreign Application Priority Data
Mar. 4, 2010 (EP) 10 002 244.1

(51) Int. Cl. G06K 9/00; H04N 7/18

(52) U.S. Cl. 348/149; 382/104; 348/E07.085

(57) ABSTRACT

A method and device are described which are configured to establish whether a traffic sign has at least one graphical feature extending linearly thereon. A portion of image data which represents at least a portion of the traffic sign is identified. Coefficients of a two-dimensional spectral representation of the portion of the image data are calculated. The coefficients of the two-dimensional spectral representation are determined for Fourier space coordinates disposed along a line in Fourier space. Based on the determined coefficients it is established whether the traffic sign has the at least one graphical feature extending linearly on the traffic sign.

### RELATED APPLICATIONS

This application claims priority of European Patent Application Serial Number 10 002,244.1, filed on Mar. 4, 2010, titled METHOD AND DEVICE FOR CLASSIFYING A TRAFFIC SIGN, which application is incorporated in its entirety by reference in this application.

### BACKGROUND OF THE INVENTION

1. Field of the Invention

The invention relates to a method and a device for classifying a traffic sign and, in particular, a method and device configured to establish whether a traffic sign includes one or more graphical features extending linearly on the sign.

2. Related Art

Contemporary vehicles are equipped with various different sensors. Vehicle sensors include sensors for detecting variables that are related to the status of the vehicle itself, as well as sensors for detecting variables of the environment surrounding the vehicle. Sensors of the second type include temperature sensors, distance sensors and, more recently, one or several cameras.

A vehicle may be equipped with a single or a plurality of cameras mounted at different positions and configured to monitor the environment of the vehicle. Such cameras may be specifically designed to capture images of a certain sector of a vehicle's environment. Data obtained from the camera(s) are employed for a variety of purposes. A basic class of functions, for which image data captured by a camera may be employed, is the field of driver assistance systems. Driver assistance systems cover a large range of functions. Systems exist that provide a driver with particular information, for example a warning in the case of possible emergency situations inside or outside the vehicle. Other driver assistance systems further enhance a driver's comfort by interfering with or partly taking over control functions in complicated or critical driving situations. Examples for the latter class of driver assistance systems are antilock brake systems (ABS), traction control systems (PCS), and electronic stability programs (ESP). Further systems include adaptive cruise control, intelligent speed adaptation, and predictive safety systems.

Some functions in Advanced Driver Assistance Systems (ADAS) may be based on an automatic recognition of traffic signs, which allows a traffic sign included in image data captured by a camera to be automatically recognized. For illustration, based on the information available from speed limit signs and end-of-restriction signs, additional support functions could be provided to enhance the driver's comfort. Such support functions may include the outputting of a warning when a speed limit violation occurs, implementing automatic adjustments to vehicle setting responsive to the detected speed limit, or other assistance functions. While information on traffic signs may be included in digital map data stored onboard a vehicle, frequent updates of the map data may be required to keep the traffic sign information up to date. Further, such information on traffic signs may not be adapted to accommodate traffic signs that are set up only for a limited period of time, e.g. in the case of road construction work. Therefore, the provision of digital map data which includes information on traffic signs does not obviate the need for methods and devices for classifying traffic signs. Furthermore, if the digital map data are generated at least partially based on recorded video images or similar, traffic sign classification may need to be performed in the process of generating the digital map data.

Methods for recognizing traffic signs may employ, for example, classification methods based on an Adaboost algorithm, neural networks, or support vector machines (SVM). While classification may lead to a full identification of the traffic sign, classification may also be implemented such that it established whether a traffic sign belongs to one of several classes of traffic signs. For some functions in ADAS that rely on the automatic recognition of traffic signs, the time required for classifying a traffic sign may be critical. Further, for some functions in ADAS that rely on the automatic recognition of traffic signs, false positive detections, i.e. classifications in which a traffic sign is incorrectly classified as belonging to a given class of traffic signs, should be low.

Therefore, there is a need in the art for improved methods and devices for classifying a traffic sign. In particular, there is a need in the art for a method and device for classifying a traffic sign, which is configured to reliably establish whether a traffic sign has one or more stripes extending essentially linearly on the traffic sign. There is further a need in the art for such a method and device which is adapted to classify a traffic sign having one or more stripes in its interior in a short time.

### SUMMARY

According to one aspect of the invention, a method for classifying a traffic sign is provided that includes establishing whether the traffic sign has at least one graphical feature extending linearly thereon. The at least one graphical feature extending linearly on the traffic sign may for example be one or more lines or stripes extending linearly on the traffic sign. In the method, a portion of image data representing at least a portion of the traffic sign is identified. The portion of the image data has, for a plurality of positions that are identified by a first image coordinate and by a second image coordinate, respectively a value that may correspond to a color or brightness information associated with the pair of image coordinate. For example, each pair of image coordinates of the portion of the image data may have a grayscale value associated with it. The portion of the image data may thus be considered to represent a two-dimensional function of the first and second image coordinates. A two-dimensional spectral representation may be calculated for the portion of the image data. Coefficients of the two-dimensional spectral representation are determined for Fourier space coordinates disposed along a line in Fourier space, the line having a selected direction in Fourier space. Based on the determined coefficients, it is established whether the traffic sign has the at least one graphical feature extending linearly on the traffic sign.

According to another aspect of the invention, a computer program product is provided having stored thereon instructions which, when executed by a processor of an electronic device, direct the electronic device to identify a portion of image data representing at least a portion of a traffic sign, calculate coefficients of a two-dimensional spectral representation of the portion of image data, determine the coefficients of the two-dimensional spectral representation for Fourier space coordinates disposed along a line in Fourier space, and establish, based on the determined coefficients, whether the traffic sign has at least one graphical feature extending linearly on the traffic sign.

In addition, a device for classifying a traffic sign is provided. The device comprises an input configured to receive image data and a processing device coupled to the input to receive the image data. The processing device is configured to identify a portion of the image data representing at least a portion of the traffic sign, to calculate a two-dimensional spectral representation of the portion of the image data, to determine coefficients of the two-dimensional spectral representation for Fourier space coordinates disposed along a line in Fourier space and to establish, based on the determined coefficients, whether the traffic sign has at least one graphical feature extending linearly on the traffic sign.

As has been explained with regard to the methods according to various aspects and embodiments above, a device having this configuration is adapted to establish whether the traffic sign has at least one graphical feature extending linearly on the traffic sign. The establishing may be based on a spectral representation of a portion of the image data. The spectral representation may be efficiently calculated. Further, information included in the spectral representation may be utilized in further image recognition, for example, as feature attributes in support vector machines.

The device may further comprise a camera coupled to the input to provide the image data thereto. Thereby, traffic signs in an environment of a vehicle may be classified.

The device may be configured to perform the method of any one aspect or implementation described herein. In particular, the processing device may be configured to perform the various transforming and calculating steps described with reference to the methods according to various aspects or implementations.

A driver assistance system for a vehicle is also provided. The system includes a device for recognizing a traffic sign, at least one input device electronically coupled to the device for receiving image data representing at least a portion of the traffic sign, a vehicle on-board network, and a user interface. The device is configured to identify a portion of image data representing at least a portion of a traffic sign, calculate coefficients of a two-dimensional spectral representation of the portion of image data, determine the coefficients of the two-dimensional spectral representation for Fourier space coordinates disposed along a line in Fourier space, and establish, based on the determined coefficients, whether the traffic sign has at least one graphical feature extending linearly on the traffic sign.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic block diagram representation of one implementation of a vehicle system equipped with a driver assistance device for classifying a traffic sign according to the present invention.

FIG. 2A is schematic representation of image data representing an end-of-all-restrictions traffic sign.

FIG. 2B illustrates a portion of image data corresponding to an interior region of the traffic sign of FIG. 2A.

FIG. 3 illustrates in a grayscale representation the modulus of the coefficients of a two-dimensional spectral representation of the portion of the image data of FIG. 2B.

FIG. 4 is a schematic representation of the Fourier space illustrating the modulus of coefficients of a discrete Fourier transform of the portion of image data of FIG. 2B.

FIG. 5 is a schematic representation of a function in coordinate space that is calculated based on the coefficients of the two-dimensional spectral representation of FIG. 3.

FIG. 6 is a flow diagram illustrating one implementation of a method for classifying a traffic sign according to the present invention.

FIG. 7A is another schematic representation of image data representing an end-of-all-restrictions traffic sign.

FIG. 7B illustrates functions in image space that have been determined by applying the method of FIG. 6 to image data representing the traffic sign of FIG. 7A.

FIG. 7C illustrates a function in image space that has been determined by applying the method of FIG. 6 to image data representing the traffic sign of FIG. 7A when filtering and normalization are employed.

FIG. 8A is schematic representation of image data representing an end-of-no-passing traffic sign.

FIG. 8B illustrates functions in image space that have been determined by applying the method of FIG. 6 to image data representing the traffic sign of FIG. 8A.

FIG. 9 illustrates a spectral representation of the modulus of coefficients obtained by performing a discrete two-dimensional Fourier transform on a color-inverted end-of-all-restrictions sign.

FIG. 10A is a schematic illustration of a two-dimensional function representing graphical features on a traffic sign.

FIG. 10B illustrates a schematic representation of the Fourier space for the function of FIG. 10A.

FIG. 10B illustrates a parallel projection along the T-direction of the Fourier space of FIG. 10B.

FIG. 11 is a flow diagram representation of a method for classifying a traffic sign according to another implementation of the present invention.

### DETAILED DESCRIPTION

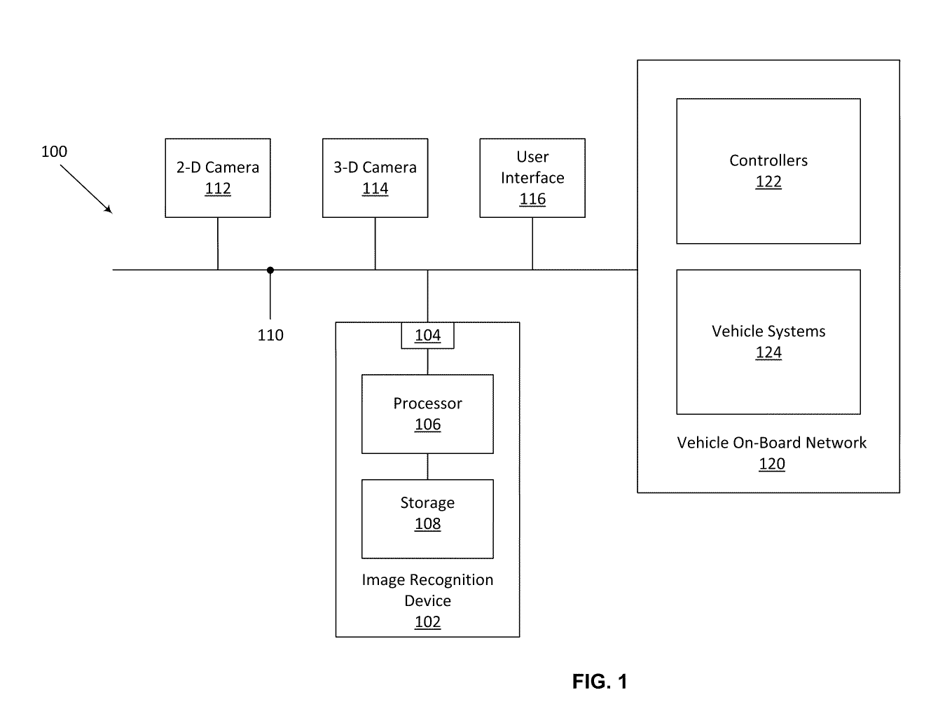

FIGS. 1-11 illustrate various implementations of systems and methods for classifying traffic signs according to the present invention. These systems and methods are configured to determine whether a traffic sign has at least one graphical feature that extends linearly on the traffic sign. As illustrated in the figures, for illustration purposes only, examples of such traffic signs may include end-of-restriction signs used in various countries, such as Germany.

In the various implementations of the present invention, image data (or at least a portion thereof) captured from the traffic sign may be transformed from image space (i.e., a space having image pixels as coordinates) to Fourier space (i.e., a space having spatial frequencies of a set of periodically varying orthonormal basis functions as coordinates) and processed through various operations, such as performing transforms from image space to Fourier space. Each pixel of image data may have has associated with it at least one value and the image data may be interpreted to be a two-dimensional (2D) data field or signal. For example, the values associated with the pixels of the image data may be grayscale values of a grayscale image. If the image data contains color information, each pixel the color tuple of a color model, such as RGB, CMYK or similar, may be converted to grayscale before the various operations are performed thereon. Alternatively, the various operations may also be performed on one of the values of a color tuple of a color model.

As used herein, and in accordance with the terminology in the art of image recognition, a two-dimensional spectral representation of the image data provides the coefficients of a series expansion of the two-dimensional image data, when interpreted as a two-dimensional function, in orthonormal basis functions. The orthonormal basis functions may be such that they respectively vary periodically as a function of the image coordinates with a well-defined spatial frequency. Examples for two-dimensional spectral representations include two-dimensional Fourier transforms, two-dimensional cosine transforms, and two-dimensional sine transforms, it being understood that there are discrete and continuous variants of such transforms and that the transforms may be numerically calculated using various algorithms, such as fast Fourier transforms (FFT) or other efficient algorithms.

Further, as used herein, and in accordance with the terminology in the art of image recognition, the term Fourier space refers to a space having coordinates that correspond to spatial frequencies of the orthonormal basis functions in which the series expansion of the image data is calculated. The term Fourier space does not imply that the two-dimensional spectral representation has to be a Fourier transform of the portion of the image data, but equally refers to a space having coordinates that correspond to spatial frequencies of the orthonormal basis functions in which the series expansion of the image data is calculated when the orthonormal basis functions are, for example, cosine functions or sine functions. Sometimes, the Fourier space is also referred to as k-space in the art of image recognition. For illustration, a pair of coordinates k₁, k₂ in Fourier space is associated with a basis function of the spectral decomposition having a first spatial frequency along a first image coordinate axis x₁ that is determined by k₁, and having a second spatial frequency along a second image coordinate axis x₂ that is determined by k₂. For illustration rather than limitation, the basis function associated with the pair of coordinates k₁, k₂ in Fourier space may be the product of a cosine varying as a function of k₁·x₁·π/N₁ and a cosine varying as a function of k₂·x₂·π/N₂, where N₁ and N₂ denote the total number of image points along the x₁- and x₂-directions, respectively. Coefficients of the spectral representation evaluated along a line in Fourier space may be the set of coefficients U(k₁, k₂) of the spectral representation with k₁ and k₂ disposed along a line in Fourier space.

FIG. 1 is schematic representation of one example of a driver assistance device 100 of the present invention coupled to a vehicle on-board network 120. The driver assistance device 100 may include an image recognition device 102 configured to classify traffic signs according to any one of the methods described herein. The driver assistance device 100 may further includes a two-dimensional (2D) camera 112, a three-dimensional (3D) camera 114 and a user interface 116. The image recognition device 102, the 2D camera 112 and the 3D camera 114 are electronically coupled to each other and to the vehicle on-board network 120 via a bus 110. The vehicle on-board network 120 may include various controllers or vehicle bus 110 that are adapted to affect the performance of the vehicle. For example, these controllers or vehicle systems 122, 124 may include antilock brake systems (ABS), traction control systems (TCS), and electronic stability programs (ESP).

The 2D camera 112 may be adapted to capture images of an environment surrounding a vehicle in which the driver assistance device 100 is installed. The 2D camera may include a charge coupled device (CCD) sensor or any other sensor adapted to receive electromagnetic radiation and provide image data representing an image of the environment of the vehicle to the image recognition device 102. The image captured by the 2D camera includes, for a plurality of image pixels, at least a grayscale value or a color-tuple that is convertible to a grayscale or brightness information.

The 3D camera 114 may be adapted to capture a 3D image of the environment of the vehicle. A 3D image may include a depth map of the field of view (FOV) of the 3D camera 114. The depth map includes distance information for a plurality of directions in the FOV of the 3D camera, mapped onto the pixels of the 3D image. The 3D camera 114 has a FOV overlapping with a FOV of the 2D camera 112. The 3D camera 114 may include a time of flight (TOF) sensor, e.g., a Photonic Mixer Device (PDM) sensor. While the driver assistance system 100 is shown to have a 3D camera 114, which may be utilized in identifying a portion of the image data provided by the 2D camera that corresponds to a traffic sign, the 3D camera may be omitted in other implementations.

The image recognition device 102 may include an interface 104 coupled to the bus 110 to receive image data from the 2D camera 112 and, if provided, 3D image data from the 3D camera 114. The image recognition device 102 may also include a processing device 106 which may include one or more processors configured to process the image data. The image recognition device 102 may further include a computer program product, such as a storage medium 108 for storing instruction code which, when executed by the processing device 106, causes the processing device 106 to process image data provided by the 2D camera 112 to determine whether the traffic sign has at least one graphical feature such as, for example, a line or stripe, or a plurality of lines or stripes that extend linearly on the traffic sign. The storage medium 108 may include, for example, a CD-ROM, a CD-R/W, a DVD, a persistent memory, a flash-memory, a semiconductor memory, a hard drive memory, or any other suitable removable storage medium.

The image recognition device 102 is configured such that the processing device 106, in operation, receives image data representing a 2D image. The processing device 106 processes the image data to identify a portion of the image data that represents at least a portion of a traffic sign and determines whether the traffic sign includes one or more graphical features that extend linearly on the traffic sign. The processing device 106 may be configured to perform a transform on the captured portion of image data in order to calculate a two-dimensional spectral representation of the data. The transform may include, for example, a discrete cosine transform (DCT), a discrete sine transform (DST), or a discrete Fourier transform (DFT). The coefficients determined using any one of these transforms may also be used as feature attributes in further image recognition steps, for example, in support vector machines. Further, such transforms may be calculated in an efficient manner, thereby, the time overhead required for establishing whether the traffic sign has at least one graphical feature extending linearly on the traffic sign may be kept moderate.

The processing device 106 may be configured to calculate the transform using a fast algorithm, such as a discrete Fourier transform algorithm. The processing device 106 may also be configured to evaluate coefficients of the spectral representation (i.e., the portion of the image data transformed into the spectral domain) along one or more lines in Fourier space.

The processing device 106 may be configured such that, in order to identify a portion of image data that represents at least a portion of a traffic sign, a shape-recognition may be performed. In one implementation, a circular Hough transformation may be performed to identify traffic signs having a circular shape in the image data. In another implementation, the 3D image data provided by the 3D camera 114 may be utilized to identify traffic signs. The 3D image data may include a depth map and thereby provide a segmentation of the environment of the vehicle. The 3D image data provided by the 3D camera 114 may be evaluated to identify, in the image data provided by the 2D camera 112, substantially planar objects having a size and/or shape that correspond to a traffic sign.

In one implementation, the processing device 106 may be configured such that, in order to calculate a two-dimensional spectral representation of the portion of the image data, a discrete cosine transform

$$U ( {k}_{1} , {k}_{2} ) = {\sum }_{{n}_{1} = 0}^{{N}_{1} - 1} {\sum }_{{n}_{2} = 0}^{{N}_{2} - 1} u ( {n}_{1} \cdot {n}_{2} ) \cdot cos [ \frac{π}{{N}_{1}} \cdot ( {n}_{1} + \frac{1}{2} ) \cdot {k}_{1} ] \cdot cos [ \frac{π}{{N}_{2}} \cdot ( {n}_{2} + \frac{1}{2} ) \cdot {k}_{1} ] \qquad ( 1 )$$

is calculated. Here, u(n₁, n₂) represents a value, for example, a grayscale value, associated with a pixel having coordinates (n₁, n₂) in image space. N₁ represents a total number of pixels in the portion of the image data in a first spatial direction. N₂ represents a total number of pixels in the portion of the image data in a second spatial direction orthogonal to the first spatial direction, k₁ and k₂ represent spatial variation frequencies of the cosine base functions of the spectral representation in Eq. (1), with 0≦k₁≦N₁−1 and 0≦k₂≦N₂−1. U(k₁,k₂) is the coefficient of the spectral representation in cosine functions associated with the spatial frequencies k₁ and k₂ along the x₁ and x₂-axis, respectively. Those skilled in the art will appreciate that other known variants of discrete cosine transforms may also be employed without departing spirit and scope of the present invention.

Alternatively, the processing device 106 may be configured such that, in order to calculate a two-dimensional spectral representation of the captured portion of image data, a discrete Fourier transform

$$U ( {k}_{1} , {k}_{2} ) = {\sum }_{{n}_{1} = 0}^{{N}_{1} - 1} {\sum }_{{n}_{2} = 0}^{{N}_{2} - 1} u ( {n}_{1} \cdot {n}_{2} ) \cdot exp [ - \frac{2 π}{{N}_{1}} \cdot i \cdot {n}_{1} \cdot {k}_{1} ] \cdot exp [ - \frac{2 π}{{N}_{2}} \cdot i \cdot {n}_{2} \cdot {k}_{2} ] \qquad ( 2 )$$

is calculated, where U(k₁,k₂) is the coefficient of the spectral representation in exponentials with imaginary arguments associated with the spatial frequencies k₁ and k₂ along the x₁ and x₂-axis, respectively. All other variables in Eq. (2) are defined as explained with reference to Eq. (1).

The processing device 106 may be configured such that, in order to detect whether the traffic sign has one or more graphical features extending linearly on the traffic sign, the coefficients of the spectral representation U(k₁, k₂) are analyzed for values of (k₁, k₂) located along a line in Fourier space. In one implementation, the processing device 106 may be configured to analyze the coefficients U(k₁, k₂) for 0≦k₁≦N₁−1 and k₂=└p·k₁+q┘=floor(p·k₁+q) where p and q are rational values characterizing the line in Fourier space along which U (k₁, k₂) is evaluated. Here, floor(·) denotes the floor function.

In another implementation, the processing device 106 may be configured to analyze the coefficients U(k₁, k₂) for 0≦k₁≦N₁−1 and k₂=┌p·k₁+q┐=ceiling(p·k₁+q), where p and q are rational values characterizing the line in Fourier space along which U(k₁, k₂) is evaluated. Here, ceiling(·) denotes the ceiling function. It will be appreciated that, for a finite number of image space coordinates, the value of k₂ defined as indicated above may need to be transformed to the domain ranging from 0 to N₂−1 by subtraction of multiples of N₂, in order to satisfy 0≦k₂≦N₂−1. As such techniques are well known in the art of image recognition, a detailed explanation of such techniques has been omitted here for brevity.

The line in Fourier space from which the coefficients of the spectral representation U(k₁, k₂) are taken for further analysis (i.e., the parameters p and q) may be selected based on the known orientation of graphical features that extend linearly on traffic signs when the traffic signs are correctly oriented relative to the street. For example, if it is desired to classify traffic signs by establishing whether or not a traffic sign has one or more lines extending at a slope of p′ throughout the traffic sign in an image space coordinate system, the parameters p and q may be selected to be p=−1/p′ and q=0 or q=N₂−1 (i.e., the line in Fourier space may be selected to pass through the point in Fourier space associated with a slowly varying function in real space and may be oriented such that it is essentially orthogonal to the direction along which the graphical features extend on the traffic sign in image space).

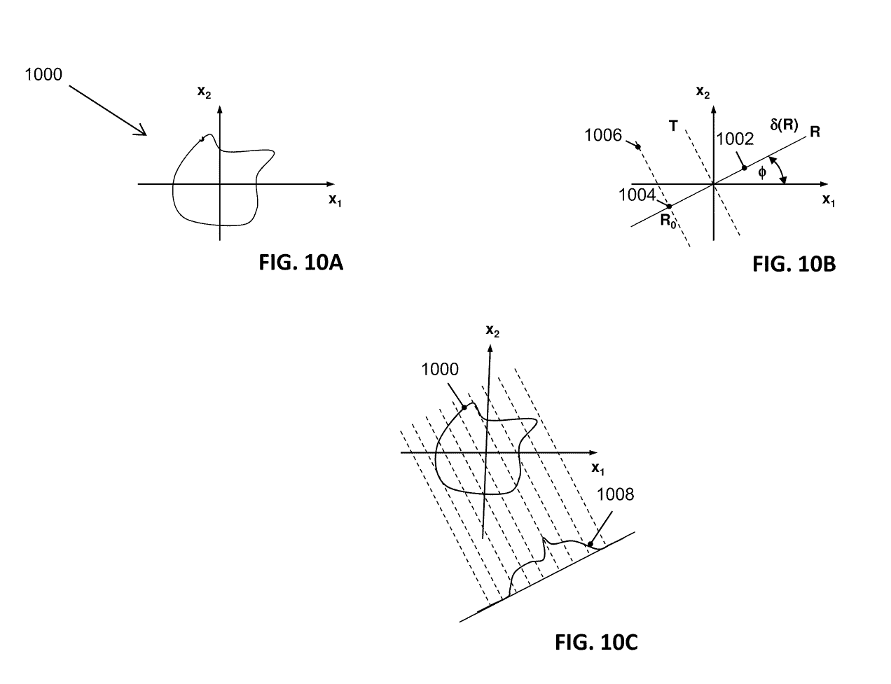

Along this chosen line in Fourier space, a resulting function in image space provides an estimate for a Radon transformation of the captured portion of image data by transforming the values U(k₁, k₂) with (k1, k2) positioned along the line in Fourier space back from Fourier space to image space using, for example, a one-dimensional inverse discrete cosine transform (IDCT) or a one-dimensional inverse discrete Fourier transform (IDFT), as will be explained in more detail later with reference to FIG. 10. The Radon transformation of the portion of the image data is indicative of line integrals over the portion of the image data and allows the presence of linearly extending graphical features to be identified. In such an implementation, the decision on whether the traffic sign has features extending linearly thereon is based upon the Fourier coefficients for points disposed along the line in Fourier space, but is independent of the Fourier coefficients associated with points that are offset from the line in Fourier space.

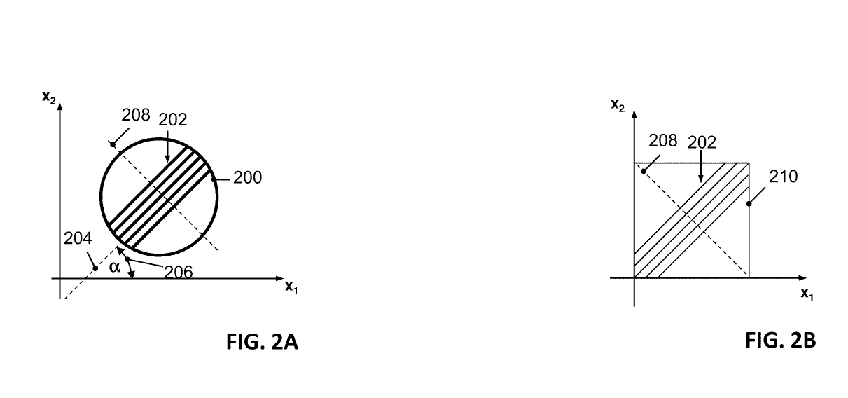

In one implementation of the present invention, it may be desired to classify traffic signs by determining whether or not a traffic sign has a plurality of lines or other indicia extending at an angle of 45° relative to a first image space coordinate axis. This implementation may be applied, for example, to an end-of-restriction sign used in Germany, as illustrated in FIG. 2A. In many countries, end-of-restriction signs are a class of signs having, as a common feature, one or several linearly extending features.

In this example, the coefficients of the spectral representation U(k₁, k₂=N₂−1−k₁) associated with values of (k₁, k₂) located along a line oriented at 1402° relative to the first Fourier space coordinate axis may be analysed and the processing device 106 may be configured to transform U(k₁, k₂=N₂−1−k₁) from Fourier space to image space using, for example, a one-dimensional inverse discrete cosine transform (IDCT), a one-dimensional inverse discrete Fourier transform (IDFT), or any other suitable transform. The resulting function in image space will exhibit pronounced dips or peaks indicative of the one or more lines extending on the traffic sign at an angle of 45°, if present.

The processing device 106 may also be configured such that the coefficients of the spectral representation U(k₁, k₂) for values of (k₁, k₂) located on two or more different lines may be analyzed to determine whether the traffic sign has one or more graphical features, such as lines or stripes, that extend linearly on the traffic sign. Thereby, traffic signs may be classified according to various classes of traffic signs having graphical features extending linearly in different directions thereon.

Referring now back to FIG. 1, the image recognition device 102 (via the storage medium 108) of the driver assistance system 100 may be configured such that, depending on whether or not a traffic sign has one or a series of parallel lines extending thereon in a given direction, the processing device 106 analyzes the image data further. For example, if it has been determined that a traffic sign is an end-of-restriction sign, the image data may be provided to a classifier such as, for example, a support vector machine, a neural network, or an AdaBoost algorithm to identify which type of end-of-restriction sign the traffic sign represents.

In one implementation, the processing device 106 may be configured to determine whether an end-of-restriction sign indicates the end of a specific speed limit or the end of all restrictions. This analysis performed by the processing device 106 may be based on the spectral representation of the portion of captured image data that has been determined to establish whether the traffic sign has one or more graphical features extending linearly thereon.

The image recognition device 102 (via the storage medium 108) of the driver assistance system 100 may be configured such that, depending on the result of an image recognition process, a signal is output to the user interface 116. For example, if the user interface 116 includes a display upon which a current speed limit is shown, the storage medium 108 may provide information to a display controller indicating that an end-of-restriction sign has been detected. Responsive to this information, the display controller may update the speed limit information output via the user interface 116.

Referring to FIGS. 2-5, the operation of an implementation of the processing device 106 of the image recognition 102 of the present invention will be explained in more detail with reference to an exemplary traffic sign.

In particular, FIG. 2A illustrates image data representing a traffic sign 200. In this example, the traffic sign may be an end-of-all-restrictions traffic sign used in Germany. The traffic sign 200 may include a series of stripes 202 extending parallel along a direction 204 on the traffic sign. As shown, when the traffic sign has its conventional orientation relative to the street, the direction 204 encloses, for example, an angle a of 45° (indicated at 206) with the positive horizontal axis (x₁) in image space. The angle a is the angle enclosed by the first image space coordinate axis and the direction along which the graphical features on the traffic sign extend linearly, taken in quadrants I and IV (upper half plane) of the image space coordinate system.

FIG. 2B illustrates a portion of image data 210 corresponding to an interior region of the traffic sign 200 of FIG. 2A. The traffic sign and the portion in its interior may be identified in the image data 210 using, for example, a circular Hough transformation or image segmentation based on 3D image data provided by the 3D camera 114 (FIG. 1). If, for example, the image data includes color information, the image data 210 may, but does not need to, be converted to a grayscale representation. The series of parallel lines 202 indicated in FIG. 2B may be, for example, represented as a function

u(x₁,x₂)=1−(δₓ_{₁}₋ₓ_{₂}+δₓ_{₁}₋ₓ_{₂}₊ₐ+δₓ_{₁}₋ₓ_{₂}₋ₐ+δₓ_{₁}₋ₓ_{₂}_{+2·a}+δₓ_{₁}₋ₓ_{₂}_{-2·a}) (3)

with the discrete Dirac δ-function having a value of 1 when its index is zero and a value of 0 otherwise, where “a” denotes a spacing between neighbouring lines in the x₂-direction. The portion 210 of the image data may be selected to have a rectangular shape with N₁ pixels in the x₁ direction and N₂ pixels in the x₂ direction. The portion 210 of the image data may be selected to have, for example, a square shape with N₁=N₂.

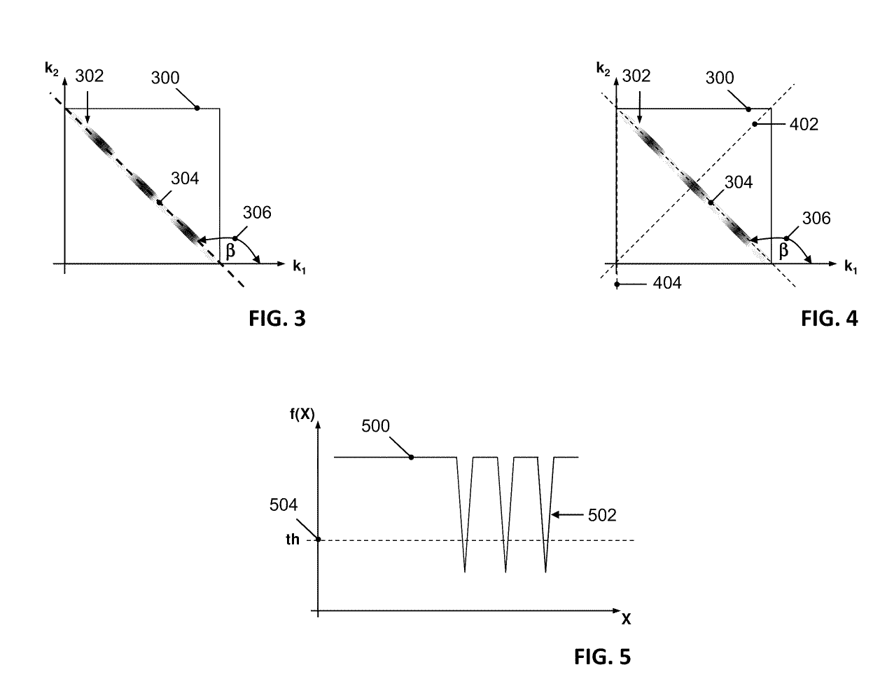

FIG. 3 illustrates in a grayscale representation (shown in Fourier space 300) the modulus of the coefficients U(k₁, k₂) of a spectral representation of the portion 26 of the image data of FIG. 2B. In this example, the modulus |U(k₁, k₂)| of coefficients may determined by a discrete Fourier transform. In the grayscale representation of FIG. 3, large values are indicated by dark colors, while values of zero are indicated in white. As illustrated, a significant spectral weight may be found only in a region 302 of Fourier space 300 that extends linearly in a direction essentially perpendicular to the direction of the plurality of stripes 202 (FIG. 2B) in the image data 210. The coefficients U(k₁, k₂) may therefore be further analyzed for values of (k₁, k₂) disposed along a line 304 in Fourier space, for example, for k₂=N₂−1−k₁. Thus, coefficients of the two-dimensional spectral representation may be determined for Fourier space coordinates disposed along a line in Fourier space which passes through the point in Fourier space associated with a basis function of the spectral decomposition which exhibits a slow spatial variation in image space, for example, a constant function.

The line 304 in Fourier space 300 maybe selected such that it is essentially perpendicular to the direction 204 (FIG. 2A) along which the stripes 202 (FIG. 2A) extend on the traffic sign 200 (FIG. 2A) in image space. As illustrated in FIG. 3, the line 304 encloses an angle β (indicated at 34) with the positive k₁-axis in Fourier space 300. The angle β is measured between the positive k₁ axis in Fourier space 300 and the line 304 in quadrants I and IV of the Fourier space coordinate system. The line 304 in Fourier space has a direction such that 85°≦|β−α|≦95°, in particular such that 88°≦|β−α|≦92°, in particular such that 89°≦|β−α|≦91°, in particular such that 90°. In other words, the direction of the line 304 in Fourier space may be selected such that it is orthogonal, to within ±5°, to the direction along which the graphical feature, if present, extends on the traffic sign in image space. Thereby, the sensitivity in recognizing traffic signs having linearly extending graphical features disposed along a specific direction may be enhanced.

While FIG. 3 indicates one line 304 in Fourier space 300 from which the coefficients of the spectral representation are taken for further analysis, it may be desirable to identify whether there is at least one graphical feature on the traffic sign that extends linearly thereon in a first direction, and whether there is at least one graphical feature on the traffic sign which extends linearly thereon in a second direction different from a first direction. Further, while the direction of graphical features on the traffic sign relative to, for example, a road surface may theoretically be known for the case in which the traffic sign is perfectly oriented, a varying distance of the camera 112 (FIG. 1) from the road side, optical imperfections in image acquisition, or incorrect positioning of the traffic sign itself may have the effect that the image of the traffic sign in the image data is angularly shifted. It may be desirable to determine whether the traffic sign has one or more linearly extending graphical features even in such scenarios. In some implementations of the present invention, the coefficients of the spectral representation may be further analyzed for values of the spatial frequencies (k₁, k₂) disposed not only along one, but along multiple lines in Fourier space 300.

FIG. 4 is a graphical representation of the Fourier space 300 which schematically illustrates the modulus of coefficients of a discrete Fourier transform of the portion 26 of the image data 210 of FIG. 2B. In this figure, additional lines 402 and 404 are illustrated in Fourier space 300 (FIG. 3) from which the coefficients of the spectral representation may be taken for further analysis. For illustration, the line 402 in Fourier space 300 (FIG. 3) is given by (k₁, k₂=k₁) with 0≦k₁≦N₁−1, and the line 404 in Fourier space 300 (FIG. 3) is given by (0, k₂) with 0≦k₂≦N₂−1. As there is only a small spectral weight along most of the line 402 in Fourier space, in the implementation shown, the processing device 106 (FIG. 2) may determine that the portion of the image data does not have graphical features extending linearly at an angle of 135°, for example, perpendicular to the direction of the line 402 in Fourier space, in the portion 26 (FIG. 2B) of the image data. Similarly, as there is only a small spectral weight along most of the line 404 in Fourier space, the processing device 106 may establish that the portion of the image data does not have graphical features extending linearly in a horizontal direction (i.e., perpendicular to the direction of the line 404 in Fourier space) in the portion 26 (FIG. 2A) of the image data.

Alternatively, the coefficients of the spectral representation that are evaluated to establish whether there are linearly extending features on the traffic sign may be taken from lines that are angularly offset by a small angle, for example, of less than or equal to 5° from the line(s) 304 (FIG. 3) in Fourier space 300 (FIG. 3) that extend perpendicularly to the expected direction of the graphical feature in image space. Analyzing the coefficients of the spectral representation evaluated at spatial frequencies disposed along such lines may aid the classification in cases in which the traffic sign is angularly offset relative to its theoretically expected orientation.

FIG. 5 is a graphical representation of a function 500 in image space. The function f(X) is obtained by transforming the coefficients of the spectral representation, determined for values of the spatial frequencies (k₁, k₂) along a line 302 in Fourier space 300, back to image space. The function 500 in image space may be calculated by the processing device 106 (FIG. 1) by performing, for example, a one-dimensional IDFT, a one-dimensional IDCT, a one-dimensional IDST, or any other suitable transform. The function 500 in image space may exhibit pronounced dips 502. The dips 502 in the function 500 indicate that the line-integral along the direction 204 (FIG. 2A) of the graphical features in the image data, calculated for various positions along a line 208 (FIG. 2B) that extends perpendicular to the direction of the graphical features in the portion 26 (FIG. 2B) of the image data exhibits a pronounced feature when the integral is performed along one of the graphical features 202 (FIG. 2B), for example, along one of the parallel five stripes 202 shown in FIG. 2A. Depending on the specific implementation of the transform from Fourier space back to image space that is used to calculate the function f(X) in image space, the number and position of peaks or dips in f(X) does not necessarily have to be in one-to-one correspondence with the number and position of linearly extending graphical features in the original image data. However, pronounced features, such as peaks or dips, may be identified in f(X) that allow the processing device 106 (FIG. 1) to establish that one or more linearly extending graphical features are present in the portion of the image data (i.e., on the traffic sign) that extends along a direction in image space which is correlated with the direction in Fourier space from which the coefficients of the spectral representation have been taken to calculate f(X).

The processing device 106 (FIG. 1) may be configured to perform a threshold comparison for f(X) to determine whether the traffic sign falls into the class of traffic signs having graphical features extending linearly thereon in a given direction. For example, a comparison with a threshold 504 may be performed. If f(X) is less than the threshold 504 for at least some values of X (i.e., for at least some image space coordinates), the processing device 106 (FIG. 1) may establish that the traffic sign falls into the class of traffic signs having graphical features extending linearly thereon in a given direction. Using the threshold comparison, a robust identification of the presence of absence of linearly extending graphical features on the traffic sign may be implemented.

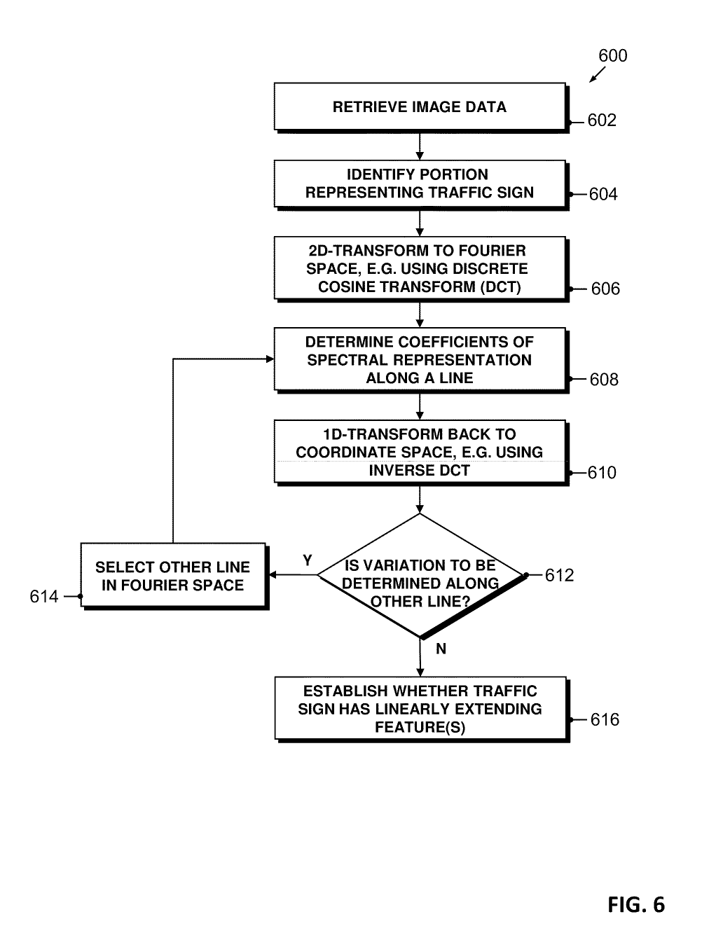

FIG. 6 is a flow diagram representation of one implementation of a method for classifying a traffic sign according to the present invention. The method, indicated herein as 600, may be performed by the image recognition device 102 of the driver assistance device 100 of FIG. 1. According to this method 600, a classification of a traffic sign is performed. Classifying the traffic sign may include establishing whether the traffic sign has at least one graphical feature extending linearly thereon.

In particular, at step 602, image data may be retrieved. In one implementation, the image data may include two-dimensional (2D) image data retrieved from a 2D camera, such as the 2D camera 112 (FIG. 2) of the driver assistance device 100. Alternatively or additionally, the image data may be retrieved from a storage medium, for example when automatically evaluating previously recorded images.

At step 604, a portion of the image data that represents a traffic sign is identified. The portion representing a traffic sign may be identified using a suitable image segmentation method. For example, if it is desired to classify traffic signs by establishing whether a circular traffic sign has at least one graphical feature extending linearly thereon, the identifying at step 604 may involve calculating a circular Hough transformation. Alternatively or additionally, identifying the portion of the image data may be based on 3D image data provided by a 3D camera, for example, the 3D camera 114 (FIG. 1) of the driver assistance device 100.

At step 606, coefficients of a two-dimensional spectral representation of the portion of the image data are calculated. Calculating the two-dimensional spectral representation may involve calculating a two-dimensional discrete Fourier transform, a two-dimensional discrete cosine transform, a two-dimensional discrete sine transform, or any other suitable transform.

At step 608, coefficients of the spectral representation may be determined for Fourier space coordinates located along a line in Fourier space. As the coefficients have previously been calculated at step 606, the determining at step 608 may be implemented by identifying coefficients of the spectral representation that are associated with given coordinates in Fourier space, located along a line in Fourier space. The coefficients of the spectral representation may be determined for coordinates in Fourier space that are disposed along a line having a pre-determined direction in Fourier space. The pre-determined direction in Fourier space may be a direction selected based on a direction along which the at least one graphical feature, if present, extends on the traffic sign. Various traffic signs, such as end of restriction signs in Germany, have graphical features that extend linearly in a specific direction (e.g., five stripes extending at an angle of 45° from the positive horizontal direction on an end-of-restriction sign in Germany). By selecting the direction of the line in Fourier space based on the a priori known possible directions of graphical features on traffic signs, the detection sensitivity may be selectively enhanced for traffic signs having graphical features extending linearly along a given direction.

Alternatively or additionally, the pre-determined direction in Fourier space may be one of a number of pre-determined directions that are different from each other. The pre-determined directions may be such that, based on the coefficients of the spectral representation for Fourier space coordinates along the plural pre-determined directions, it may be established whether the traffic sign belongs to a class of traffic signs having at least one graphical feature extending linearly thereon in one of a number of different directions.

At step 610, a function in image space is calculated based on the coefficients of the spectral representation associated with Fourier space coordinates that are disposed along a line in Fourier space. To calculate the spectral representation, a one-dimensional transform of the coefficients may be calculated. For example, the coefficients may be subject to a transform that is a one-dimensional inverse discrete Fourier transform, a one-dimensional inverse discrete cosine transform or a one-dimensional inverse discrete sine transform. The transform employed at step 610 to calculate the function in image space may be the inverse, although in one dimension, of the transform employed at step 606 to calculate the two-dimensional spectral representation.

At step 612, it is determined whether the coefficients are to be determined for at least one other line in Fourier space. If the coefficients are to be determined for at least one other line in Fourier space, the other line is selected at step 614 and the method returns to step 608.

At step 616, it is determined whether the traffic sign has at least one graphical feature extending linearly thereon. The process of determination at step 616 may be performed based on the function(s) in image space determined at step 610. This process at step 616 may involve determining whether the function(s) in image space have one or more pronounced changes in functional value. A threshold comparison may respectively be performed to establish, for each one of the functions determined at step 610, whether the function has at least some functional values smaller or greater than a pre-determined threshold. The position at which a pronounced change in functional value occurs may be compared to the expected position of lines in known traffic signs.

In other implementations, additional steps may be included in the method. For instance, a filtering may be performed in the Fourier domain before the one-dimensional transform back to image space is calculated. The filtering may be performed, for example, to compensate for image blurring. The filtering may be performed on the two-dimensional spectral transform calculated at step 606 or on the coefficients along the line in Fourier space determined at step 608. A |f|-ramp filter may be used.

In other implementations, a normalization may be applied to the function in image space calculated at step 616 before a threshold comparison is performed. The function calculated at step 616 may be normalized so that the normalized function has a maximum value of 1 prior to performing the threshold comparison.

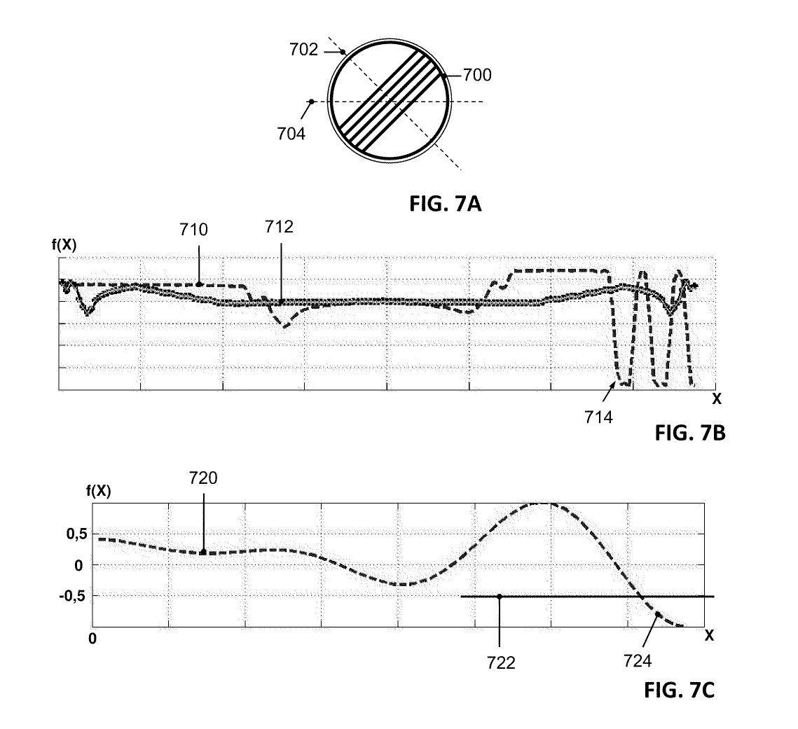

Turning now to FIGS. 7-9, illustrate example implementations of methods and devices for classifying traffic signs according to the present invention. In particular, FIG. 7A illustrates an example of an end-of-all-restrictions sign 700 used in Germany. FIG. 7B depicts functions 710, 712 in image space that have been determined by applying, for example, the method of FIG. 6 to image data representing the traffic sign 700. The function 710 may be determined by performing a two-dimensional discrete cosine transform on a portion of the image data, determining the coefficients U(k₁, k₂) for Fourier space coordinates disposed along a line that is directed at 135° relative to the k₁-axis, and performing a one-dimensional inverse discrete cosine transform on the coefficients U(k₁, k₂), back to image space. The function 712 is determined by determining the coefficients U(k₁, k₂) for Fourier space coordinates disposed along a line that is directed at 0° relative to the k₁-axis (i.e., that is parallel to the k₁-axis), and performing a one-dimensional inverse discrete cosine transform on the coefficients U(k₁, k₂), back to image space.

As shown, the function 710 may exhibit pronounced dips 714, however, the function 712 does not exhibit a similar behavior. By comparing the functions 710 and 712, it may be determined that the traffic sign has lines extending perpendicularly to the line indicated at 702 in FIG. 7A, but does not have lines that extend linearly on the traffic sign in a direction perpendicular to the line indicated at 704 in FIG. 7A.

As can be seen in FIG. 7B, depending on the specific implementation of the transform that is performed on the portion of the image data to calculate the coefficients of the spectral representation, and depending on the inverse one-dimensional transform, the number and position of pronounced peaks or dips in the function 710 in image space need not always be identical to the number and positions of the linearly extending graphical features in the image data. In particular, when cosine or sine transforms are employed, some information may be lost as compared to the original data, which may have the effect that not each line present in the image data may be identified as a separated peak or dip in the function f(X). However, the presence or absence of such graphical features having a given direction may be established based on the function 710 in image space.

FIG. 7C depicts a function 720 in image space that has been determined by applying, for example, the method of FIG. 6 to image data representing the traffic sign 700 when filtering and normalization are employed. More specifically, to address blurring effects, the illustrated function 720 has been calculated by applying an |f|-ramp filter to the coefficients U(k₁, k₂) for Fourier space coordinates disposed along a line that is directed at 135° relative to the k₁-axis, by transforming the filtered coefficients to image space and by normalizing the result, such that the maximum value of the function f(X) in image space is one. While the filtering suppresses pronounced variations in f(X), the five stripes extending perpendicularly to the line 702 indicated in FIG. 7A causes f(X) to have small values in at least one region, as indicated at 724. The values of the function f(X) in image space may be compared to a threshold 722 to establish whether the traffic sign 700 has linearly extending features directed perpendicularly to the line 702 indicated in FIG. 7A.

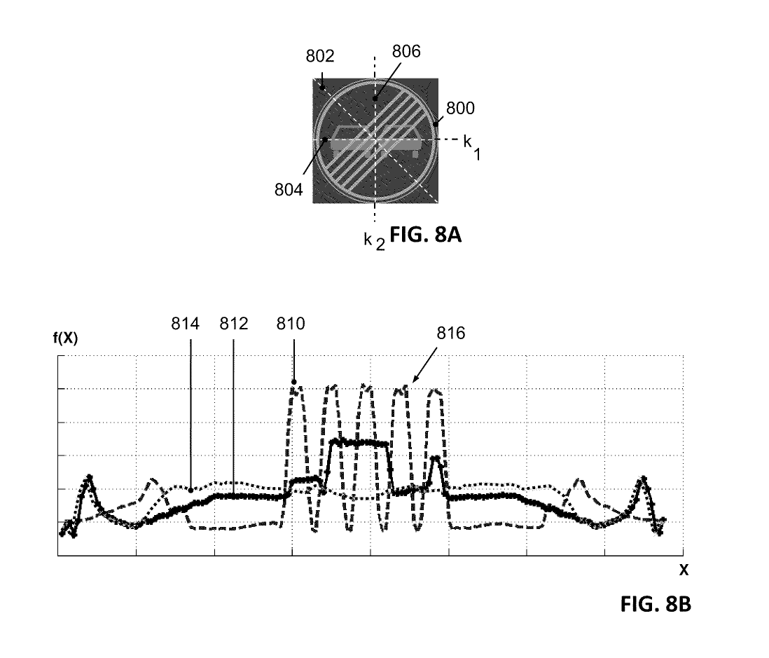

In another example, FIG. 8A illustrates an end-of-no-passing sign 800 used in Germany. In this example, an inversion of grayscales has been performed on the image data, with white color being associated with high grayscale values.

FIG. 8B shows functions 810-814 in image space that have been determined by applying, for example, the method of FIG. 6 to image data representing the traffic sign 800. The function 810 is determined by performing a two-dimensional discrete Fourier transform on the portion of the image data, determining the coefficients U(k₁, k₂) for Fourier space coordinates disposed along a line that is directed at 135° relative to the k₁axis, and performing a one-dimensional inverse discrete Fourier transform on the coefficients U(k₁, k₂), back to image space. The function 812 is determined by determining the coefficients U(k₁, k₂) for Fourier space coordinates disposed along a line that is directed at 90° relative to the k₁-axis (i.e., that is parallel to the k₂-axis), and performing a one-dimensional inverse discrete Fourier transform on the coefficients U(k₁, k₂), back to image space. The function 814 is determined by determining the coefficients U(k₁, k₂) for Fourier space coordinates disposed along a line that is directed at 0° relative to the k₁-axis (i.e., that is parallel to the k₁-axis, and performing a one-dimensional inverse discrete Fourier transform on the thus determined coefficients back to image space). The function 810 exhibits pronounced peaks 68 having a number and position corresponding to the number and position of lines in the portion 800 of the image data. The functions 812 and 814 also show some variation, due to the presence of the grey car symbols in the traffic sign, but do not exhibit the same pronounced peaks as the function 810. By comparing the function 810 to the functions 812 and 814, it may be established that the traffic sign has lines extending perpendicularly to the line indicated at 802 in FIG. 8A, but that there are no lines of comparable brightness and length that extend linearly on the traffic sign in a direction perpendicular to the lines indicated at 804 and 806 in FIG. 8A.

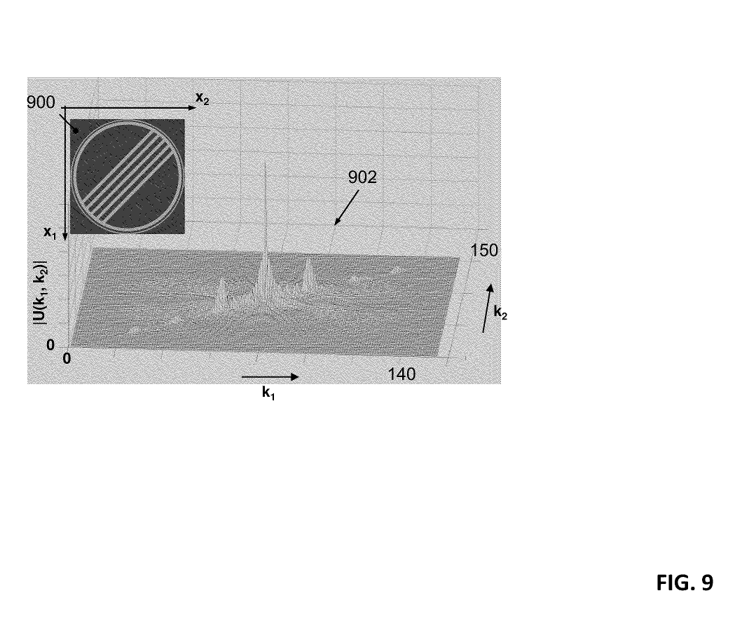

FIG. 9 depicts the modulus of coefficients |U(k₁, k₂)|obtained by performing a discrete two-dimensional Fourier transform on a color-inverted end-of-all-restrictions sign 900, such as those used in Germany. In this example, the image space coordinate system has been chosen such portion of the image data, determining the coefficients U(k₁, k₂) for Fourier space coordinates disposed along a line that is directed at 135° relative to the k₁-axis, and performing a one-dimensional inverse discrete Fourier transform on the coefficients U(k₁, k₂), back to image space. The function 812 is determined by determining the coefficients U(k₁, k₂) for Fourier space coordinates disposed along a line that is directed at 90° relative to the k₁-axis (i.e., that is parallel to the k₂-axis), and performing a one-dimensional inverse discrete Fourier transform on the coefficients U(k₁, k₂), back to image space. The function 814 is determined by determining the coefficients U(k₁, k₂) for Fourier space coordinates disposed along a line that is directed at 0° relative to the k₁-axis (i.e., that is parallel to the k₁-axis, and performing a one-dimensional inverse discrete Fourier transform on the thus determined coefficients back to image space). The function 810 exhibits pronounced peaks 68 having a number and position corresponding to the number and position of lines in the portion 800 of the image data. The functions 812 and 814 also show some variation, due to the presence of the grey car symbols in the traffic sign, but do not exhibit the same pronounced peaks as the function 810. By comparing the function 810 to the functions 812 and 814, it may be established that the traffic sign has lines extending perpendicularly to the line indicated at 802 in FIG. 8A, but that there are no lines of comparable brightness and length that extend linearly on the traffic sign in a direction perpendicular to the lines indicated at 804 and 806 in FIG. 8A.

FIG. 9 depicts the modulus of coefficients |U(k₁, k₂)|obtained by performing a discrete two-dimensional Fourier transform on a color-inverted end-of-all-restrictions sign 900, such as those used in Germany. In this example, the image space coordinate system has been chosen such that the origin of the image space coordinate system is in the top left corner of the end-of-restriction sign 900, so that the five stripes extending across the sign, extend at an angle of 135° relative to the positive x₁-axis. As illustrated by 3D spectral graph 902, a significant spectral weight of the Fourier spectral representation is concentrated along the line k₁=k₂ in Fourier space, where |U(k₁, k₂)| has high values. By analyzing the coefficients of the spectral representation along the line k₁=k₂ in Fourier space, it may thus be determined whether the traffic sign has one or more graphical features extending at an angle of 135° relative to the positive x₁-axis.

While the operation of methods and devices has been explained in the context of exemplarily traffic signs with reference to FIGS. 2-5 and 7-9, the methods and devices may generally be utilized to establish whether a traffic sign has one or more graphical features that extend linearly thereon. The methods and devices of the present invention may be configured to analyze coefficients of a spectral representation for Fourier space coordinates along a line in Fourier space, as will be explained in more detail with reference to FIG. 10.

FIG. 10A shows a schematic illustration 1000 of a two-dimensional function u(x₁, x₂) representing graphical features on a traffic sign. By performing a two-dimensional Fourier transform, a spectral representation of u(x₁, x₂) is provided by its Fourier transform U(k₁, k₂). The Fourier transform U(k₁, k₂) may be evaluated along a line in Fourier space. Assuming that the Fourier transform U(k₁, k₂) is evaluated along a line in Fourier space having an angle of φ (FIG. 10B) relative to the k₁-axis and passing through (k₁, k₂)=(0, 0), the Fourier space coordinates of the line may be parameterized as (k₁, k₂)=k·(cos φ, sin φ). For a given value of φ (FIG. 10B), this function may also be referred to as Uₚ(k, φ).

FIG. 10C illustrates this parallel projection along the T-direction. For reasons of clarity, the R-axis is shown offset from the origin of the image space coordinate system. The line integrals over u(x₁, x₂) respectively taken over the broken lines schematically indicated in FIG. 10C provide the function uₚ(R, φ) illustrated at 1008, which may be determined from the two-dimensional Fourier transform of u(x₁, x₂) evaluated along a line in Fourier space. The line integrals exhibit pronounced peaks or dips when they are taken along a graphical feature that extends linearly on the traffic sign and in a direction parallel to the line of projection T. Consequently, such linearly extending graphical features may be determined from the function uₚ(R, φ) calculated according to Eq. (4). As has been explained above, cosine or sine transforms may be employed instead of the Fourier transform indicated in Eq. (4) to establish whether linearly extending graphical features are present on a traffic sign, as the resulting image space function still exhibits peaks or dips as they are found in the Radon transformation.

It will be appreciated that the central slice theorem mentioned in the context of Eq. (4) above may, for example, be derived from the fact that the Radon transformation may be considered to be a convolution of u(x₁, x₂) and a Dirac delta function associated with the Dirac line 1002 indicated in FIG. 10B. In Fourier space, the convolution of the two image space functions translates into a product of the Fourier transforms. The Fourier transform of the Dirac line, which corresponds to the line 1002, is again a Dirac line, and the Radon transformation of u(x₁, x₂) may therefore be determined by performing a one-dimensional transform from Fourier space to image space on Uₚ(k, φ).

In the methods and devices of the present invention, classification of the traffic sign may continue after it has been determined whether or not the traffic sign belongs to a class of traffic signs having graphical features extending linearly thereon.

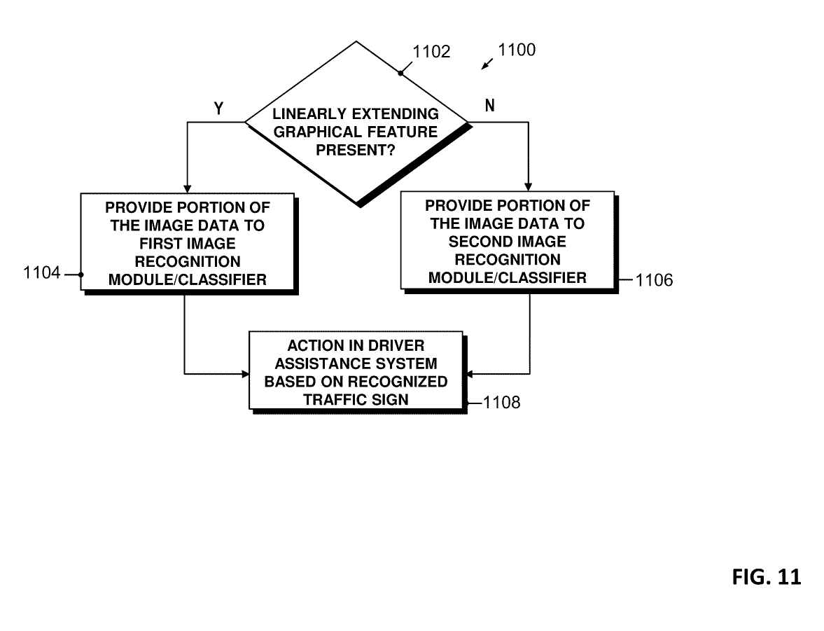

FIG. 11 is a flow diagram representation of a method 1100 for classifying a traffic sign according to an implementation of the present invention. The method 1100 may be performed by the driver assistance device according to any one of the implementations described above.

The method 1100 starts with step 1102, where the driver assistance device determines whether the traffic sign has at least one graphical feature extending linearly thereon. The determining step 1102 may be implemented such that only traffic signs having graphical features extending along one given direction, or one of multiple given directions, will be identified. The determining step 1102 may be implemented using, for example, one of the methods described with reference to FIG. 6.

If it is determined at step 1102 that the traffic sign has at least one graphical feature extending linearly thereon in one given direction or one of multiple given directions, at step 1104, the portion of captured image data is provided to a first image recognition module or classifier. If it is determined at step 1102 that the traffic sign does not have at least one graphical feature extending linearly thereon in one given direction or one of multiple given directions, at step 1106, the portion of captured image data is provided to a second image recognition module or classifier different from the first image recognition module or classifier. The first and second image recognition modules may respectively be configured to perform further classification of the traffic sign. The first and second image recognition module may respectively be implemented using a support vector machine, a neural network, or an Adaboost algorithm. The first and second image recognition modules may be different from each other with regard to the feature attributes that are evaluated and/or with regard to the specific implementation of the image recognition module.

Additional classification of the captured portion of image data at steps 1104 or 1106, respectively, may also be based on at least one of the coefficients of the spectral representation that has previously been calculated at step 1102. Coefficients of a spectral representation determined by, for example, a discrete cosine transform or a discrete Fourier transform, as determined at step 1102, are feature attributes that may be used in the classification at steps 1104 and 1106.

At step 1108, an action in a driver assistance device may be initiated based on a result of the additional image recognition performed at steps 1104 or 1106, respectively.

While embodiments of the present invention have been described with reference to the drawings herein, various modifications and alterations may be implemented in other implementations. For example, while methods and devices of the present invention have been described which determine, for example, a spectral representation of a portion of image data by performing a Fourier transform or a discrete Fourier transform, other transforms, such as discrete cosine transforms, may be utilized in other implementations to determine coefficients of a spectral representation. Further, while the line in Fourier space from which the coefficients of the spectral representation are taken has been shown to pass through a point in Fourier space that is associated with slowly varying base function of the spectral decomposition, the line in Fourier space may also be offset from such a point, for example, in order to establish whether the traffic sign has one or plural broken stripes thereon which respectively exhibit a given periodicity.

In addition, while some implementations of the present invention are described herein in the context of driver assistance systems provided onboard of vehicles, methods and devices of the present invention may also be implemented in other fields of application, such as the analysis of previously recorded image sequences for generating digital maps. Further, unless explicitly stated otherwise, the features of the various implementations may be combined with each other.

While it is expected that implementations of the invention may be advantageously utilized in image recognition performed onboard a vehicle, the field of application are not limited thereto. Rather, embodiments of the invention may be used in any system or application in which it is desirable or required to classify traffic signs. To that end, methods and devices according to the various aspects and implementations of the invention may be utilized in all fields of application in which it is desirable or required to classify or recognize a traffic sign. It is anticipated that driver assistance systems installed in vehicles, or methods and systems for automatic feature extraction that may be utilized to generate digital maps are possible fields of application. However, the invention is not limited to these specific applications that are mentioned for illustration rather than limitation.

It will be understood, and is appreciated by persons skilled in the art, that one or more processes, sub-processes, or process steps described in connection with FIGS. 1-11 may be performed by hardware and/or software. If the process is performed by software, the software may reside in software memory (not shown) in a suitable electronic processing component or system such as, one or more of the functional components or modules schematically depicted in FIGS. 1-11. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, store or communicate the program for use by or in connection with the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A method of classifying a traffic sign having at least one graphical feature extending linearly thereon, the method comprising the steps of:
providing a device for capturing image data representing at least a portion of the traffic sign;
identifying the portion of image data;
calculating coefficients of a two-dimensional spectral representation of the portion of image data;
determining the coefficients of the two-dimensional spectral representation for Fourier space coordinates disposed along a line in Fourier space, the line having a selected direction in Fourier space; and
establishing, based on the determined coefficients, whether the traffic sign has at least one graphical feature extending linearly on the traffic sign.

2. The method of claim 1, where the at least one graphical feature includes one or more lines or stripes extending linearly on the traffic sign.

3. The method of claim 1, where the direction of the line in Fourier space is selected based on a direction along which the at least one graphical feature extends on the traffic sign.

4. The method of claim 3, where the at least one graphical feature extends linearly on the traffic sign in a direction having an angle of α relative to a first direction in image space, and the line in Fourier space has an angle of β relative to a first direction in Fourier space,
where the first direction in Fourier space represents spectral components associated with the first direction in image space, and
where the direction of the line in Fourier space is selected such that 85°≦|β−α|≦95°, in particular such that 88°≦|β−α|≦92°, in particular such that 89°≦|β−α|91°.

5. The method of claim 1, where a two-dimensional transform is performed on the portion of image data to calculate the coefficients of the two-dimensional spectral representation.

6. The method of claim 5, where the two-dimensional transform is a transform selected from the group consisting of a two-dimensional discrete cosine transform, a two-dimensional discrete sine transform, or a two-dimensional discrete Fourier transform.

7. The method of claim 1, where values of a Radon transformation of the portion of image data, evaluated at positions along a line in image space, are estimated based on the determined coefficients in order to establish whether the traffic sign has the at least one graphical feature extending linearly on the traffic sign.

8. The method of claim 1, where a function in image space is calculated by transforming the determined coefficients from Fourier space to image space, in order to establish whether the traffic sign has at least one graphical feature extending linearly on the traffic sign.

9. The method of claim 8, where the function in image space is calculated by performing a one-dimensional transform on the determined coefficients.

10. The method of claim 9, where the one-dimensional transform is a transform selected from the group consisting of a one-dimensional inverse discrete cosine transform, a one-dimensional inverse discrete sine transform, or a one-dimensional inverse Fourier transform.

11. The method of claim 8, where a threshold comparison is performed for the function in image space in order to establish whether the traffic sign has at least one graphical feature extending linearly on the traffic sign.

12. The method of claim 1 further comprising the step of determining the coefficients of the two-dimensional spectral representation for Fourier space coordinates disposed along at least another line in Fourier space,
where the step of establishing whether the traffic sign has the at least one graphical feature extending linearly on the traffic sign is performed based on the coefficients determined for Fourier space coordinates disposed along the line in Fourier space and based on the coefficients determined for Fourier space coordinates disposed along the at least another line in Fourier space.

13. The method of claim 1, where, based on the determined coefficients, it is established whether the traffic sign is an end-of-restriction sign.

14. The method of claim 1 further comprising the step of providing the portion of image data to at least one image recognition module for further classification of the traffic sign, where the at least one image recognition module to which the portion of image data is provided is selected from a plurality of image recognition modules based on a result of the establishing whether the traffic sign has the at least one graphical feature extending linearly on the traffic sign.

15. A computer program product having stored thereon instructions which, when executed by a processor of an electronic device, direct the electronic device to
identify a portion of image data representing at least a portion of a traffic sign;
calculate coefficients of a two-dimensional spectral representation of the portion of image data;
determine the coefficients of the two-dimensional spectral representation for Fourier space coordinates disposed along a line in Fourier space; and
establish, based on the determined coefficients, whether the traffic sign has at least one graphical feature extending linearly on the traffic sign.

16. The computer program product of claim 15, where the at least one graphical feature includes one or more lines or stripes extending linearly on the traffic sign.

17. The computer program product of claim 15, where the direction of the line in Fourier space is selected based on a direction along which the at least one graphical feature extends on the traffic sign.

18. The computer program product of claim 17, where the at least one graphical feature extends linearly on the traffic sign in a direction having an angle of α relative to a first direction in image space, and the line in Fourier space has an angle of β relative to a first direction in Fourier space,
where the first direction in Fourier space represents spectral components associated with the first direction in image space, and
where the direction of the line in Fourier space is selected such that 85°≦|β−α|≦95°, in particular such that 88°≦|β−α|≦92°, in particular such that 89°≦|β−α|91°.

19. The computer program product of claim 15, where a two-dimensional transform is performed on the portion of image data to calculate the coefficients of the two-dimensional spectral representation.

20. The computer program product of claim 20, where the two-dimensional transform is a transform selected from the group consisting of a two-dimensional discrete cosine transform, a two-dimensional discrete sine transform, or a two-dimensional discrete Fourier transform.

21. The computer program product of claim 15, where values of a Radon transformation of the portion of image data, evaluated at positions along a line in image space, are estimated based on the determined coefficients in order to establish whether the traffic sign has the at least one graphical feature extending linearly on the traffic sign.

22. The computer program product of claim 15, where a function in image space is calculated by transforming the determined coefficients from Fourier space to image space, in order to establish whether the traffic sign has at least one graphical feature extending linearly on the traffic sign.

23. The computer program product of claim 22, where the function in image space is calculated by performing a one-dimensional transform on the determined coefficients.

24. The computer program product of claim 23, where the one-dimensional transform is a transform selected from the group consisting of a one-dimensional inverse discrete cosine transform, a one-dimensional inverse discrete sine transform, or a one-dimensional inverse Fourier transform.

25. The computer program product of claim 22, where a threshold comparison is performed for the function in image space in order to establish whether the traffic sign has at least one graphical feature extending linearly on the traffic sign.

26. The computer program product of claim 15, where the product determines the coefficients of the two-dimensional spectral representation for Fourier space coordinates disposed along at least another line in Fourier space,
where the process of establishing whether the traffic sign has the at least one graphical feature extending linearly on the traffic sign is performed based on the coefficients determined for Fourier space coordinates disposed along the line in Fourier space and based on the coefficients determined for Fourier space coordinates disposed along the at least another line in Fourier space.

27. The computer program product of claim 15, where the product provides the portion of image data to at least one image recognition module for further classification of the traffic sign, where the at least one image recognition module to which the portion of image data is provided is selected from a plurality of image recognition modules based on a result of the establishing whether the traffic sign has the at least one graphical feature extending linearly on the traffic sign.

28. The computer program product of claim 15, where the computer program product comprises a storage medium on which the instructions are stored.

29. The computer program product of claim 29, where the storage medium may be selected from a group of removable storage medium consisting of a CD-ROM, a CD-R/W, a DVD, a persistent memory, a Flash-memory, a semiconductor memory, or a hard drive memory.

30. A device for classifying a traffic sign comprising:
an input configured to receive image data; and
a processing device coupled to the input to receive the image data, the processing device being configured to identify a portion of the image data representing at least a portion of the traffic sign;
calculate coefficients of a two-dimensional spectral representation of the portion of the image data;
determine the coefficients of the two-dimensional spectral representation for Fourier space coordinates disposed along a line in Fourier space; and
establish, based on the determined coefficients, whether the traffic sign has the at least one graphical feature extending linearly on the traffic sign.

31. The device of claim 30, where the at least one graphical feature includes one or more lines or stripes extending linearly on the traffic sign.

32. The device of claim 30, where the direction of the line in Fourier space is selected based on a direction along which the at least one graphical feature extends on the traffic sign.

33. The device of claim 32, where the at least one graphical feature extends linearly on the traffic sign in a direction having an angle of α relative to a first direction in image space, and the line in Fourier space has an angle of β relative to a first direction in Fourier space,
where the first direction in Fourier space represents spectral components associated with the first direction in image space, and
where the direction of the line in Fourier space is selected such that 85°≦|β−α|95°, in particular such that 88°≦|β−α|≦92°, in particular such that 89°≦|β−α|≦91°.

34. The device of claim 30, where a two-dimensional transform is performed on the portion of image data to calculate the coefficients of the two-dimensional spectral representation.

35. The device of claim 34, where the two-dimensional transform is a transform selected from the group consisting of a two-dimensional discrete cosine transform, a two-dimensional discrete sine transform, or a two-dimensional discrete Fourier transform.

36. The device of claim 30, where values of a Radon transformation of the portion of image data, evaluated at positions along a line in image space, are estimated based on the determined coefficients in order to establish whether the traffic sign has the at least one graphical feature extending linearly on the traffic sign.

37. The device of claim 30, where a function in image space is calculated by transforming the determined coefficients from Fourier space to image space, in order to establish whether the traffic sign has at least one graphical feature extending linearly on the traffic sign.

38. The device of claim 37, where the function in image space is calculated by performing a one-dimensional transform on the determined coefficients.

39. The device of claim 38, where the one-dimensional transform is a transform selected from the group consisting of a one-dimensional inverse discrete cosine transform, a one-dimensional inverse discrete sine transform, or a one-dimensional inverse Fourier transform.

40. The device of claim 37, where a threshold comparison is performed for the function in image space in order to establish whether the traffic sign has at least one graphical feature extending linearly on the traffic sign.

41. The device of claim 30, where device determines the coefficients of the two-dimensional spectral representation for Fourier space coordinates disposed along at least another line in Fourier space,
where the process of establishing whether the traffic sign has the at least one graphical feature extending linearly on the traffic sign is performed based on the coefficients determined for Fourier space coordinates disposed along the line in Fourier space and based on the coefficients determined for Fourier space coordinates disposed along the at least another line in Fourier space.

42. The device of claim 30, where the device provides the portion of image data to at least one image recognition module for further classification of the traffic sign, where the at least one image recognition module to which the portion of image data is provided is selected from a plurality of image recognition modules based on a result of the establishing whether the traffic sign has the at least one graphical feature extending linearly on the traffic sign.

43. A driver assistance system for a vehicle comprising:
a device for recognizing a traffic sign;
at least one input device electronically coupled to the device for receiving image data representing at least a portion of the traffic sign;
a vehicle on-board network; and
a user interface,
where the device is configured to
identify a portion of image data representing at least a portion of a traffic sign;
calculate coefficients of a two-dimensional spectral representation of the portion of image data;
determine the coefficients of the two-dimensional spectral representation for Fourier space coordinates disposed along a line in Fourier space; and
establish, based on the determined coefficients, whether the traffic sign has at least one graphical feature extending linearly on the traffic sign.

44. The driver assistance system of claim 43, where the at least one input comprises a two-dimensional camera and/or a three-dimensional camera.

45. The driver assistance system of claim 43, where the device and the at least one input are electronically coupled to each other and to the vehicle on-board network via a bus.
